(19) United States
(12) Patent Application Publication
(10) Pub. No.: US 2012/0220277 A1
(43) Pub. Date: Aug. 30, 2012

(54) PROMOTION MANAGEMENT SYSTEM AND SMARTPHONE APPLICATION

(76) Inventor: David Gonynor, Bloomfield Hills, MI (US)

(21) Appl. No.: 13/035,991

(22) Filed: Feb. 27, 2011

(51) Int. Cl. H04M 3/493

(52) U.S. Cl. 455/414.2

(57) ABSTRACT

A smartphone application for use by a user on a smartphone with geolocation capabilities, where the smartphone application has a user interface; the user interface indicates business customers in a geographical range from the user, where the business customers includes businesses contracting with an application controller; where the businesses contracting with an application controller includes promotion codes indicating the types of offers users can expect; where the user interface indicates offers from the business customers in the geographical range from the user; where the offers are not indicated if the offers are not valid at the time when the smartphone application is executed; and where offers will automatically renew based on the time frame set for the offer to be available again after redemption limits have been achieved.

### FIELD OF THE INVENTION

The present invention relates to coupon smartphone applications, and in particular, to smartphone applications for managing promotions from establishments such as restaurants and bars.

### BACKGROUND

Coupons and special deals have long been useful marketing and advertising tools. Historically, paper coupons have been distributed directly to potential consumers through direct mail, newspapers, flyers, or magazines. The advantage of paper coupons is that usage can be limited to a single usage by the customer in a particular geography. In this digital age, electronic coupons distributed via email or posted on websites have become more common. Electronic coupons have the disadvantage that it is difficult, if not impossible, to control repeated usage by customers. There are coupon sharing sites that will capture website coupons and make them available for repeated usage. Email coupons can be easily replicated regardless of attempts to limit printing.

Several companies are centered around or have applications for electronic offers distributed via smartphones. Facebook.com, Foursquare.com, Getmealticket.com, and Valpak.com are examples of such companies. These companies face challenges and have disadvantages, however. Current promotion management methods do not allow companies to designate the applicability of promotions for selected groupings of locations, for example. Current promotion management methods also do not allow companies to create one promotion applicable over a designated time frame that includes a defined variable usage period of time within that time frame.

Generally, customers want to know about the latest deals offered by these companies, as well as other information they may find of interest. They want methods to determine quickly if they are interested in the promotions. They want to see promotions that are applicable at a specific time and day, and not waste their time reviewing promotions that do not apply at that particular moment in time. These companies are not necessarily meeting these customer desires.

Therefore there is a need for a smartphone application and promotion management system that allows chains to group their locations; that allows tracking of coupon redemption; that provides for promotion viewing only when the promotion is valid; that controls how frequently an offer can be redeemed by a customer; that controls the time frame the offer will be available again after it has been redeemed; that allows promotion creation for large company chains; that provides promotion types to tell the customer what offers to expect; and that allows for easy promotion creation and messaging.

### SUMMARY OF THE INVENTION

The present invention includes a smartphone application, an offer software product, a smartphone software product, and an offer distribution system software product.

In its most basic form, the smartphone application of the present invention includes a user interface that indicates business locations in a geographical range of the user and offer types from the locations in the geographical range, where the offer types give the user an idea of the offers they can expect to see. The user can select a location to see offers associated with the offer types. Offers will not be shown if they are not valid or redeemable at the time the user selects the location. The user interface also indicates whether the offers have redemption limits and provides redemption codes if they do.

The smartphone application is for use by a user on a smartphone that has geolocation capabilities. A smartphone is a mobile phone that offers more advanced computing ability and connectivity than a mobile phone with telephonic features only. Smartphones are akin to handheld computers integrated with a mobile telephone, and may run complete operating system software providing a platform for advanced applications. Geolocation capabilities use GPS technology to geographically locate the user of the smartphone. When the smartphone application is initiated, it detects the user's location and allows the application to display a set number of locations of certain businesses in a geographical range from the user at that moment. This is the first page of the user interface. The locations are provided to the smartphone application by a provider, such as those marketed under the Yelp or Google trademarks that make location listings accessible via an API. Some of these locations will be owned or operated by business customers that have contracted with an application controller to be among the businesses that extend offers to users through the smartphone application. These business customers develop the offers through the offer software product of the present invention, as discussed below. Business customers may be stores, but are preferably bars and restaurants.

The geographical range may be different for different types of locations. In an urban area, for example, the geographical range may be only a five block radius, or other easily walkable distance. In a suburban area, however, where the user is likely to be driving, the geographical range may be a short drivable distance. In some embodiments of the smartphone application, the user may enter the desired geographical range.

The offer types are also listed on the first page of the user interface. They are preferably two or three letter codes that indicate what type of offers the user can expect to see if they select the location including that code from the list. The presence of offer types also indicates to the user that the location is a business customer of the smartphone application, rather than merely a location generated by another API. In other words, all locations in the geographical range will be listed for the user, but offer types will only appear with those locations that are business customers of the smartphone application. Thus the appearance of the offer types lets the user know that he may expect offers from those locations.

The codes for the offer types may be “CO” for “check it out offer,” “DC” for “daily coupon,” “WC” for “weekly coupon,” “MC” for “monthly coupon,” “HH” for “happy hour,” and/or “ES” for “early bird special,” for example. These codes immediately give the user some information about the offer, such as how frequently it is offered (e.g. daily, weekly, or monthly), or the likely time window for which the offer will be available (e.g. 5-7 pm for a happy hour, or 4-6 pm for an early bird special). Offer types are not relegated to discounts and coupons, however. There may also be an “EN” code for entertainment that gives information about entertainment opportunities at a location, rather than discounts. One of ordinary skill in the art will recognize that there are many different types of offers and offer types that are included in the present invention. Although two or three letter codes are presented as the preferred embodiment, there are also many different ways that the type of the offer may be indicated, such as by icons or other indications, for example.

More than one offer type may be listed with a location indicating that that location is currently offering more than one offer. In one embodiment of the present invention, offer types corresponding to all offers available to any user are indicated with the location. In another embodiment of the present invention, only those offer types corresponding to offers available to the particular user are indicated with the location. In this latter embodiment, for example, if a user has already redeemed in that week an offer that is only available for redemption once a week, then the corresponding offer type for that offer will not be indicated with the location on the first page of the user interface.

Locations are selectable. That is to say, a user may select a location from the list to learn more about the location and its offers. Selecting a location that includes offer types brings the user to a second page of the user interface that will provide more information on the offer(s) corresponding to the offer type(s) listed on the first page. In addition to the offer itself, the second page also includes information about the location of the business customer, such as name, address, and distance from the user, although some or all of this information may be repetitive of information provided on the first page. Other information may include links to business customer reviews, the business customer's website and/or menu, type of cuisine or setting, and relative expense.

A user may be a registered user or a guest user. A user may register with the smartphone application by providing certain limited demographic information, such as email, first name, last name, sex, birthday, and zip code. The user's mobile phone number is captured without the user's specific provision, as the smartphone application is executed on the user's mobile phone. In some embodiments, the user may opt to receive targeted offers from business customers based on the demographic information provided for registration.

The difference between a registered user's and a guest user's experience deals with redemption limits. Some offers have redemption limits. The most common redemption limits are on the number of times an individual user can redeem an offer and/or on the total number of users that can redeem the offer. When a registered user reaches the second page of the user interface of the smartphone application, only those offers that are valid and redeemable by that registered user will be listed, as the registered user's redemption of offers will have been tracked through the smartphone application. An offer is valid if the location is offering it at the time the smartphone application is executed. An offer is redeemable if a user has not exceeded a valid offer's redemption limits. When a guest user reaches the second page of the user interface of the smartphone application, all valid offers will be listed. If the guest user then selects one of the offers for redemption, the guest user will be prompted to register with the smartphone application so that the redemption may be tracked.

The user interface indicates if the offer has a redemption limit. If the offer includes a redemption limit, the user interface provides the user with a redemption code for the offer. This is preferably an alphanumeric code or a barcode, but any other type of code may be used, such as a pictorial or graphical code. It is preferred that the user present the business customer or business customer representative, such as a restaurant server, with the code by presenting the user's smartphone. It is preferred that the smartphone application indicate how many total redemption codes associated with a particular offer will be distributed, and what number out of that total the user's redemption code is. If a business customer has allocated that 500 codes may be distributed in association with a particular offer, and the user has been presented with the 352^{nd}, for example, the smartphone application may note “352/500,” for example, in addition to the code itself.

In a preferred embodiment of the smartphone application of the present invention, the user may designate favorite locations from among locations that are listed. The favorite locations are stored within the application and a list of favorite locations is easily accessible from the user interface. The user can gain quick access to their list of favorite locations and available offers at the favorite locations regardless of geographical proximity to the favorite location. The list of favorite locations is preferably sortable alphabetically or by geographical proximity, for example. Locations that are indicated as being within the geographical range of the user that have already been selected by the user as a favorite location may be highlighted or otherwise made to stand out from the rest of the list of locations. A user selects a location to be a favorite location by selecting from a list of locations provided by the smartphone application and then indicating its favorite status. The indication of favorite status may be by hitting an “Add to faves” button on the user interface, or selecting a similar option from a menu on the user interface. Although this is the preferred method of selecting favorite locations, one of ordinary skill in the art will recognize that there are several ways such selection may be achieved. The favorite location may also be entered by the user by typing or speaking a location name into the smartphone or by the user searching for and/or through locations owned or operated by business customers of the smartphone application and selecting those of interest, for example. A user may also remove a favorite location from the list of favorite locations by selecting to change a favorite location back to a non-favored location.

In a preferred embodiment of the smartphone application of the present invention, the user may select alert locations from among locations or business customers listed by the smartphone application. The designation of a location or business customer as an alert location allows that location or business customer permission to contact the user. The contact preferably includes directed offers, news, or other marketing materials and is preferably delivered via SMS, although the contact may be delivered in other manners, such as through social network websites or email. It is preferred that the alert locations not be provided with the user's contact information directly, but that contact is made possible through the smartphone application. As described above with reference to favorite locations, there are several ways that an alert location may be selected and the presence of an already designated alert location may be somehow highlighted from a more general list of locations. A user can select to change an alert location back to a non-alert location.

In its most basic form, the offer software product of the present invention includes receipt code for receiving input from a business customer and distribution code for distributing offers to a user. The input received by the receipt code includes locations operated or owned by the business customer, groupings of the locations, offers available at those locations, and information concerning the offers, such as times when the offer is valid, the types of offers, whether or not the offers have redemption limits, the redemption limits if they do, and a time frame for when a redeemed offer will be available again, if ever. The distribution code includes geolocation code for receiving geolocation information for a user; offer type code for listing types of available offers; offer code for listing offers corresponding to the offer types; and presentation code for presenting these lists to an application that is used by an end user.

The business customer may be a store, but is preferably a restaurant or bar. The business customer inputs information about its locations through the receipt code of the offer software product of the present invention. Every business customer has at least one location. A single bar owned by a sole proprietor may have only one location, for example. In this example, the business customer is likely the sole proprietor and the location is the bar location. A large chain of restaurants, on the other hand, may have many locations, and several within close proximity to one another. In this example, the business customer is likely corporate headquarters of the chain, a regional manager of the chain, or an owner of several franchises, and the locations are the locations of the various restaurants within the chain. The single bar would have only one grouping of locations, and that one grouping of locations would include the one location of the single bar only. The large chain has the opportunity to create many different groupings of locations, however.

Groupings may be based on geography, type of location, type of setting, maturity of the location, or any other basis that makes sense for the business customer. Moreover, locations may be grouped into multiple groupings if a single location falls under the categorization of multiple groupings. Using groupings, a business customer may create one offer or promotion that is applicable to one location only or to thousands of locations by entering the offer information only once. Groupings also allow a business customer to restrict the usage of a coupon to only one time across an entire grouping of locations. For example, a large chain fast food restaurant might designate all of its airport locations into one grouping and then create an offer for a free oatmeal breakfast at any of those locations. If the large chain designates a single usage, a user that uses that coupon at the Detroit airport location will not be able to use the same coupon at the Chicago airport location.

Moreover, groupings allow the locations within the groupings some autonomy, as discussed below. In preferred embodiments, for example, the offer software product also includes opt in opt out code, which allows individual locations to opt into or opt out of offers created for that location or for a grouping of which that location is a part. Preferred embodiments also include inactive code, which allows business customers to create offers for a grouping of locations and set the offer as inactive. Such embodiments also include active code, which allows the individual locations within the groupings for which the offer was created to review the inactive offers and select and activate those that they wish to offer at their location.

The business customer creates the actual offers by inputting information about the offers. The receipt code allows for the input of the information. The offers may be promotions, discounts, special deals, or whatever the business customer chooses. These are the offers that will be displayed to a user of the smartphone application of the present invention. The business customer specifies exactly when the offer is valid, such as a certain day of the week or designated times of the day. A business customer could create a Monday lunch time offer, for example, that is valid every Monday from 11 am to 2 pm for a year. In some cases, the business customer can select from offer templates that prefill the key input fields with the information that will support that type of offer. The types of offers are preferably the same as described above with reference to the smartphone application of the present invention. Specifically, the codes may be “CO” for “check it out offer,” “DC” for “daily coupon,” “WC” for “weekly coupon,” “MC” for “monthly coupon,” “HH” for “happy hour,” and/or “ES” for “early bird special.” In the Monday lunch example, the specification that the offer is only valid on Mondays would designate the offer as a weekly coupon or WC. For other offers, the business customer may designate the type of offer, such as a happy hour or early bird special. The business customer can also designate a redemption limit, such as maximum number of times the offer is redeemable by an individual user and/or the maximum total number of users that can redeem the offer. This piece of information may also be automatically filled by certain types of offers through the use of promotion templates. A weekly coupon promotion template, for example, may automatically be designated as a coupon that can be redeemed a maximum of once a week. For a happy hour offer, on the other hand, the business customer may designate that it can be redeemed a maximum of three times a week. The business customer can also indicate the time frame the offer will be available again to the user if redemptions limits are reached. Time frames can be set for the next day, the next week, the next month, or never, for example.

When the business customer creates an offer for a grouping of locations, then redemption limits for the individual user and the total redemption offer limits for all users apply to the grouping. For example, if a large restaurant chain creates a promotion for a group that contains all of its mall locations across the U.S. and the restaurant chain sets a redemption limit of a single usage of an offer for a user, then the offer will no longer be available to that user at any of the other mall locations in the grouping when they redeem the offer at any of the locations in the grouping. The same is true if the business customer sets the total number of users that can redeem the offer. Once the total number of redemptions is achieved for the mall grouping the offer will no longer be available to any other user selecting this offer for any location in the mall grouping.

In a preferred embodiment, the receipt code also includes template code, which allows for the creation of a template for certain offers as discussed above. The template code uses other input provided by the business customer through the receipt code. The template code will speed the creation of offers by prefilling fields in the offer input from a selection of available templates.

The receipt code allows for the receipt of information to create offers, as described above. The distribution code allows for the distribution of the offers to users. The geolocation code allows for the location of a user. The location code allows for the listing of locations in a geographical range of a user. The offer code compiles a list of offers available at the time of the execution of the software to be redeemed at locations within a geographical range from the user. The list of offers includes information about the offer, including the offer itself, the location where the offer is being offered, times when the offer is valid, the offer type, redemption limits on the offer, and the time frame for when the offer will be valid again, i.e. all the input received through the receipt code. Although discussed separately, it is understood that in some embodiments of distribution code 104, location code 125 and offer code 126 are combined. The presentation code allows for the presentation of the lists to an application, such as the smartphone application of the present invention, for use by an end user. The presentation code separates the information so that smartphone application may display the right information at the right time. For example, as described above, on the first screen of the user interface of the smartphone application of the present invention, only the location and offer types are shown. The offer and more information pertaining to the offer are not shown until the second screen.

In a preferred embodiment, the offer software product also includes offer type code for providing the various types of offers. Offer type code works in conjunction with the receipt code by providing the different types of offers as selections for the business customer so that the business customer may more easily enter offer type information.

In a preferred embodiment, the offer software product also includes tracking code. The tracking code allows for the tracking of the redemption of an offer. This allows business customers to run diagnostics on the success of their offers as marketing tools. It also allows business customers to ensure that users are not redeeming offers beyond the parameters set by the business customer, such as the maximum number of times the offer can be redeemed, or whether the offer has already been redeemed at one location in a grouping when only one redemption within that grouping is permitted. Offers that have been tracked as already having been redeemed within the parameters set by the business customer will not be listed for the registered user when the software is executed. Another application of the tracking code is used when the business customer has designated that the offer will only be available to a certain number of users, such as the first 500 takers, for example. The tracking code tracks how many users have redeemed the limited offer and the number is provided for the user. In a preferred embodiment, the distribution code also includes discontinuation code that prevents inclusion of an offer from the list of offers if the offer is subject to a redemption limit and the redemption limit has been met as indicated by the tracking code.

In a preferred embodiment, the offer software product also includes opt in opt out code, which allows individual locations within a grouping to opt in or opt out of offers created for the grouping by the business owner. Should a location opt out of redeeming offers created for them by the business owner, the offer code will not list the offers opted out of by that location for that location. For example, a franchisee can choose to opt out of promotions created for it by the business owner. In this case, the offer code will list no offers for the franchisee's location. If the franchisee should change its mind, it can execute the opt in opt out code to opt in so that some or all valid and active offers created for that location are listed by the offer code. A business customer can also choose to create offers for just one location.

In a preferred embodiment, the offer software product also includes inactive code, which allows the business owner to create an offer for a grouping and then select to make the offer inactive for all locations in the grouping. Such embodiments also include active code, which allows individual locations within a grouping to review promotions created for them and allow them to pick and choose which offers they would like to have listed for users of their locations.

In a preferred embodiment, the offer software product also includes texting code for sending offers to users that have chosen to receive text alerts from a particular location or business customer. Texting code includes user contact information code for receiving user contact information for users that have selected a location of the business customer as an alert location. Texting code also includes texting input code for receiving input from a business customer about the text alerts to be sent. Specifically, this input may include the message to be sent, when to send it, and what grouping of locations or individual locations will send the messages if a location within the grouping or the individual location is selected as an alert location. The message may include directed offers, news, or other marketing materials. Therefore, the texting code allows a business customer to send text alerts to a grouping of locations or an individual location at a designated date and time. The texting code also includes opt out code so that locations or business customers can opt out of sending messages even when selected by a user as an alert location. The texting code also includes sending code for sending the message to the users who selected the alert locations, preferably by SMS. Although SMS delivery is preferred, the message may be delivered in other manners, such as through social network websites or email. The user's contact information is stored so that it is not directly available to the alert location or business customer, but so that the alert location or business customer may still send messages to the user using the offer software product. An example of the feature that the texting code provides for would be a fast food chain sending a text alert promoting its new oatmeal breakfast to all users that have agreed to receive text alerts from any location owned or operated by that chain. The message in the text could be, “Be sure to check Fansrave on Feb. 4, 2011. There will be a coupon posted for a free ‘Oatmeal Breakfast.’ Check Fansrave for details between 6 am and 11 am on Feb. 4.”

In a preferred embodiment, the offer software product also includes social network code for creating and sharing information on locations and offers on social networking sites, such as those marketed under the Facebook and Twitter trademarks.

In its most basic form, the smartphone software product of the present invention includes user interface software code for providing a user interface on the smartphone; geolocation code for identifying and indicating locations within a geographical range from a user; offer type code for indicating offer types available at locations within the geographical range from the user; location selection code for allowing the user to select a location; and offer code for indicating offers corresponding to the indicated offer types that are available from the locations within the geographical range from the user on the user interface. Offers are not indicated if the offers are not valid or redeemable at a time when the smartphone software product is executed.

The smartphone software product of the present invention is executable on a smartphone with geolocation capabilities and corresponds with the smartphone application of the present invention.

In a preferred embodiment, the smartphone software product of the present invention also includes alert code for allowing a user to opt in to receive text alerts from locations selected by the user.

In a preferred embodiment, the smartphone software product of the present invention also includes registration code for allowing users to register for the service provided by the smartphone application of the present invention. The registration code allows for the input of demographic information by the user, such as email address, name, sex, birthday, and zip code.

In a preferred embodiment, the smartphone software product of the present invention also includes redemption code for providing the user with a redemption code through the smartphone user interface, where the redemption code is redeemable at locations by displaying the redemption code on the smartphone. The redemption code may be an alphanumeric code, a barcode, or any other type of code provided by the business customer. The redemption code is presented at the location, such as to a restaurant server, for redemption. If the redemption code is a bar code, the server may use bar code scanning technology to scan the bar code and the scanner can send the information of the redemption to the tracking code of the offer software product of the present invention.

In a preferred embodiment, the smartphone software product of the present invention includes favorites code for allowing a user to select favorite locations. These favorite locations are easily accessible and may be sortable when listed. Users can receive offers from favorite locations regardless of the user's geographical proximity to the favorite location.

The offer distribution system software product of the present invention includes the offer software product and the smartphone software product of the present invention. The offer distribution system software product allows for the creation of offers by business customers and the distribution of those offers to users through a smartphone application.

Therefore it is an aspect of the present invention to provide a smartphone application and software product that provide offers to a customer based on their geolocation.

It is a further aspect of the present invention to provide a smartphone application and software product that only provide offers if they are valid at the time the user is using the application and executing the software product.

It is a further aspect of the present invention to provide a smartphone application and software product that provide offer types indicating the types of offers the customers can expect to see if they select a particular business location.

It is a further aspect of the present invention to provide an offer software product that allows chains to group their locations.

It is a further aspect of the present invention to provide an offer software product that allows companies to create offers that are valid on designated days of the week and/or at designated times of the day.

It is a further aspect of the present invention to provide an offer software product that allows companies to specify when the customer can redeem the offer again.

It is a further aspect of the present invention to provide an offer software product that allows individual locations to opt in or out of offers created for them.

It is a further aspect of the present invention to provide an offer software product that allows business customers to easily and quickly create offers to be used at its locations.

It is a further aspect of the present invention to provide an offer distribution system software product that allows business customers to create offers and have those offers accessed by users through a smartphone application.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIGS. 1A-1C are depictions of screens of the smartphone application of the present invention.

FIG. 2 is a block diagram showing the functionality of the offer software product of the present invention.

FIG. 3 is a block diagram showing the functionality of the smartphone software product and smartphone application of the present invention.

### DETAILED DESCRIPTION

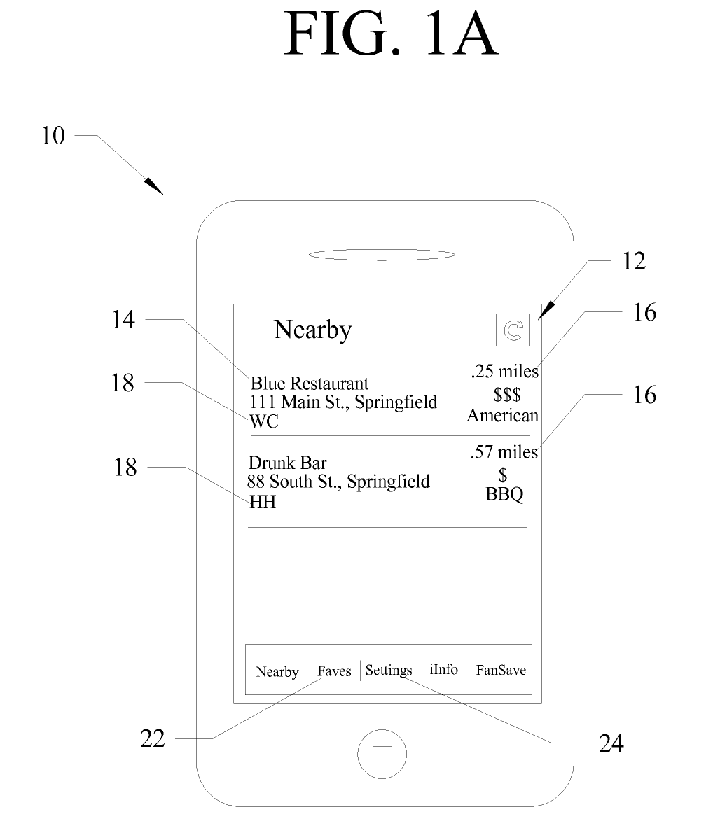

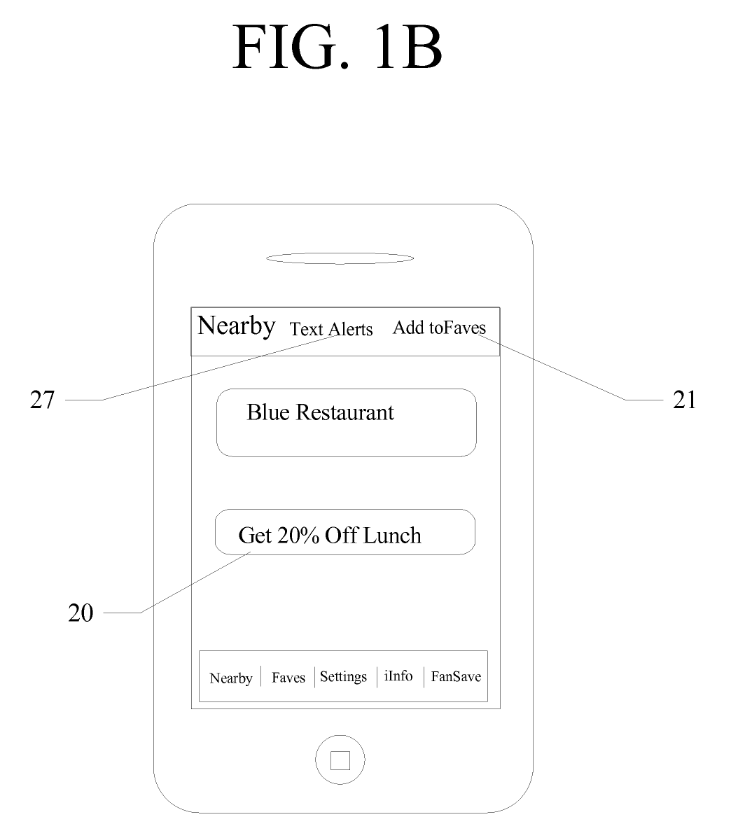

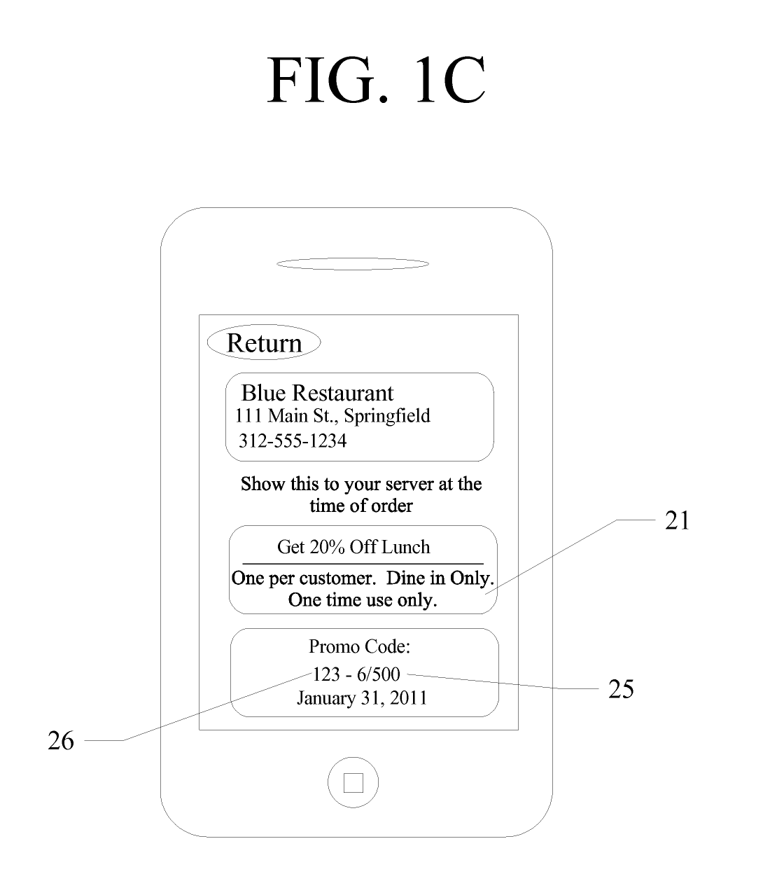

Referring first to FIGS. 1A-1C, several screens of smartphone application 10 of the present invention are shown. Smartphone application 10 is executed on a smartphone with geolocation capabilities. Although a smartphone of the type sold under the iPhone trademark is shown, it is understood that smartphone application 10 may be initiated on any smartphone. Smartphone application 10 includes user interface 12. At the time of the screenshot shown in FIG. 1A, a user has initiated smartphone application 10 so that the user's geographic location has been detected using the geolocation capabilities of the smartphone, and a list of locations 14 has been created for the user that are within a geographical range of the user.

Locations 14 are listed in order of proximity to the user's present geolocation. Location 14 listings are accessed from a “places” provider such as those marketed under the trademarks Yelp or Google. These places providers provide a list of locations 14 sorted by type of business via an API. Smartphone application 10 has a limit set to the number of locations 14 in this list.

In some embodiments, the user may adjust the geographical range by clicking on and adjusting settings 24. Faves 22 are also shown on this screen. As discussed in more detail with reference to FIG. 1B, a user may indicate that he or she wishes to add a location 14 to his list of favorite locations, allowing him to view the available offers for these locations 14 regardless of the user's geolocation. The user accesses this list through faves 22 and selects locations 14 for the list through add to faves 21, as described below with reference to FIG. 1B.

On this screen, information about locations 14 includes their names (Blue Restaurant and Drunk Bar), their physical addresses (111 Main St., Springfield and 88 South St., Springfield), the type of offer 18 being offered (“WC” for weekly coupon and “HH” for happy hour), the distance 16 from the user (0.25 miles and 0.57 miles), the approximate relative cost (fairly pricey and fairly inexpensive), and the general type of cuisine (American and barbecue). Distance 16 is always within the geographical range, which is set by smartphone application 10 or by the user through settings 24. The list of offer types 18 is selected by business customers who develop the offers for locations 14 that the business customers own or operate. The offer types 18 are indicative of the offers the user can expect to see if they select location 14. Other codes might be CO|WS|HH|EN, indicating Check It Out offer, a Weekly Special offer, a Happy Hour offer, and entertainment information, respectively. The information presented will depend on the geolocation places provider selected for the smartphone application. The location listing on FIG. 1A shows the information available if the Yelp brand places provider is selected.

In FIG. 1B, the user has selected to see more information about the offers from Blue Restaurant. If a user is a registered user the user will see all of the offers that are available at that point in time, including offers for which the user has not achieved the offer redemption limit. If a user is a guest they will see a listing of all of the offers available from that location at that point in time. Here we see more information on offer 20, which was indicated only as a weekly special on the screen in FIG. 1A. The weekly special in this case is to get 20% of lunch. Note that although only a weekly coupon was indicated as type of offer 18 in FIG. 1A, more than one type of offer 18 may have been listed in FIG. 1A, which would result in the entire list of offers 20 in FIG. 1B. Although not shown, this screen may include more information about location 14 or its corresponding business customer, or links to more information about location 14 or its corresponding business customer. Such information may include reviews, websites, menus, etc. This screen or related screens may also have options for sharing information on offer 20 or location 14 through social networking websites.

This screenshot also shows add to faves 21. By clicking on add to faves 21, the user adds location 14 to a list of favorites that may be accessed through faves 22, as shown in FIG. 1A. In so doing, the user can view promotions or offers available to the user from that location 14 at any time by accessing the list of faves 22, as shown in FIG. 1A.

This screen also shows text alerts 27. Users can opt in to receive text alert messages from a location 14 that has been selected as an alert location. That location 14 may then send the user messages through smartphone application 10, preferably through SMS. By enabling this messaging through smartphone application 10, the user may receive messages from location 14 without disclosing contact information to location 14 directly. Details on how and when the messages are sent and received are dictated on one side by location 14, or a business customer that owns or operates location 14.

FIG. 1C shows a screenshot after the user has decided to take advantage of offer 20 by selecting offer 20 on the screen shown in FIG. 1B, for example. More information for location 14 is provided, such as its phone number. If a user is a guest user they will be prompted to register with the service in order to gain access to offer 20 and associated redemption code 26. The user information is never shared with the business customer or location. For registered users, redemption code 26 is provided with instructions to show redemption code 26 to the user's server at location 14. Offer restrictions 31 are also provided, such as “One per customer. Dine in only. One-time use only.” In this case, redemption code 26 is an alphanumeric code, but redemption code 26 may be a barcode or graphic or any other type of code. Offer 20 includes redemption limit 25 that only 500 people may redeem offer 20, and indicates that the user is the 6^{th} to do so. This is indicated by “6/500” next to redemption code 26. The date of the redemption is included on this screen. In some embodiments, a countdown timer may be included showing the user how long he or she has to redeem offer 20.

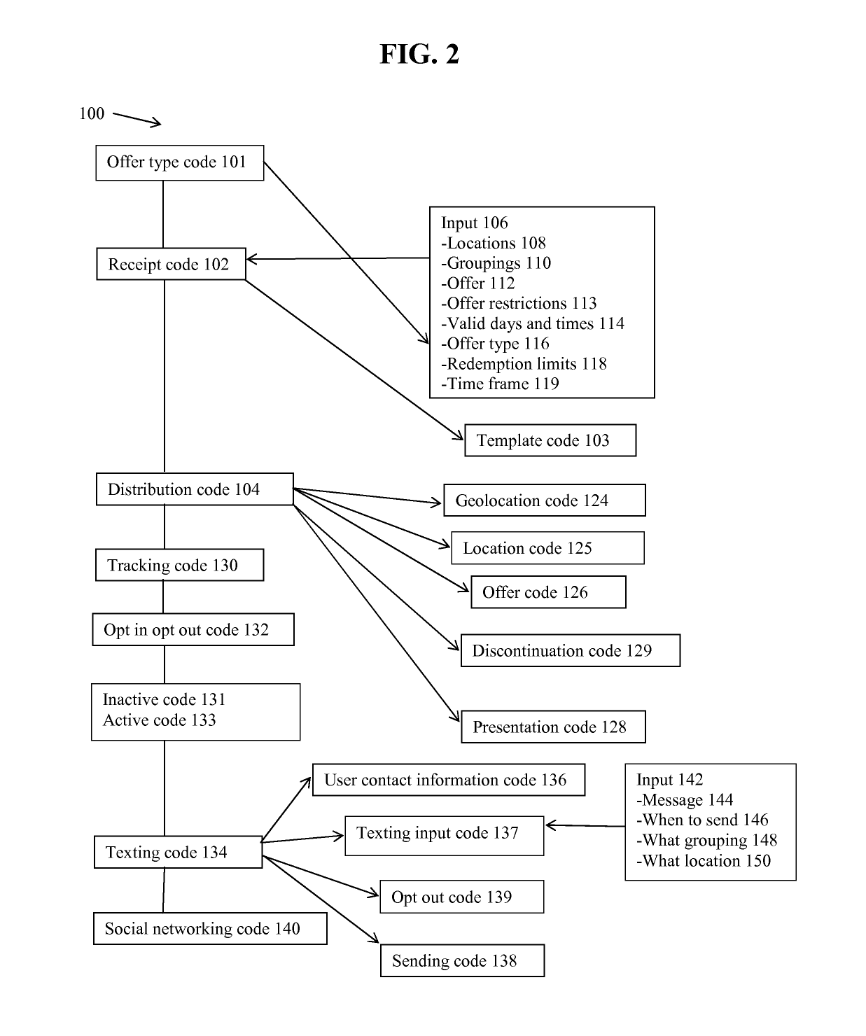

Now referring to FIG. 2, the functionality of offer software product 100 is shown. Offer software product 100 includes receipt code 102, offer type code 101, distribution code 104, tracking code 130, opt in opt out code 132, inactive code 131, active code 133, texting code 134, and social networking code 140. Receipt code 102 allows for receiving input 106 from a business customer. Input 106 includes locations 108, groupings 110 of locations 108, offers 112, offer restrictions 113, valid days and times 114 for offers 112, offer types 116, redemption limits 118 of offers 112, and offer renewal time frames 119 of offers 112. Offer type code 101 provides a listing of offer types 116 that the business customer can select from to display below its location 108 listing, as shown with respect to smartphone application 10 shown in FIG. 1A. Distribution code 104 includes geolocation code 124, location code 125, offer code 126, presentation code 128, and discontinuation code 129. Texting code 134 includes user contact information code 136, texting input code 137, opt out code 139, and sending code 138. Texting input code 137 allows for the input of at least the following information input 142 dealing with the texting feature: message 144, when to send the message 146, what grouping 148 of locations will send messages 144 if a location from the grouping is selected for message receipt, and what location 150 will send messages 144 if the location is selected for message receipt.

A business customer inputs information input 106 about its locations 108 through receipt code 102. Every business customer has at least one location 108. The business customer also inputs groupings 110 of locations 108. Groupings 110 may be based on geography, type of location, type of setting, maturity of the location, or any other basis that makes sense for the chain restaurant business customer. Moreover, locations 108 may be grouped into multiple groupings 110 allowing a single location 108 to fall under the categorization of multiple groupings 110.

The business customer then creates actual offers 112 through receipt code 102. Offers 112 may be promotions, discounts, special deals, events, information, or whatever the business customer chooses. These are offers 20 that will be displayed to a user of smartphone application 10 of the present invention. The business customer specifies which grouping 110 or individual location 108 the offer 112 is being created for. The business customer specifies if offer 112 includes any offer restrictions, such as if offer 112 is only available for dining in a restaurant, as opposed to take out or delivery. The business customer specifies exactly when offer 112 is valid 114, such as a certain day of the week and/or designated times of the day. The business customer selects the type of offer 116 through offer type code 101, which provides the various types of offers 116. Types of offers 116 may be “CO” for “check it out offer,” “DC” for “daily coupon,” “WC” for “weekly coupon,” “MC” for “monthly coupon,” “HH” for “happy hour,” “ES” for “early bird special,” or any other type of offer, update, or message. The business customer also designates if offer 112 has redemption limits 118. Redemption limits 118 may be per user or per total users. The business customer also designates time frame 119, indicating when offer 112 will be available again to a user after redemption limits 118 have been achieved (next day, next week, next month or never).

When the business customer creates offer 112 for a grouping 110, receipt code 102 creates offer 112 for each individual location 108 in grouping 110 with the same offer ID. User redemption of offer 112 and associated offer ID is tracked using tracking code 130, discussed in more detail below. A single offer ID for offer 112 in group 110 allows a business customer to limit the redemption of the offer by a user within grouping 110 of locations 108.

Receipt code 102 also includes template code 103, which allows the business owner to create offers 112 quickly by selecting pre-defined templates for certain offers 112. A template may be available for a weekly promotion, for example, that is good for the days Monday through Friday during the lunch hours limiting the user to a single usage each week. The business user selects this template and completes the remaining information using receipt code 102.

Distribution code 104 allows for the distribution of offers 112 to users. Geolocation code 124 allows for the geographic location of a user. Location code 125 allows for the listing of locations 108 in a geographical range of a user. Offer code 126 compiles a list of offers 112 available at the time of selection by the user of the location 108 whose offers 112 the user is interested in viewing. Registered users of smartphone application 10 will only see a list of available offers 112 where they have not already met redemption limits 118 set for offer 112. The list of offers 112 includes offer 112, type of offer 116, offer restrictions 113, times and dates when the offer is valid 114, redemption limits 118, and the time frame 119 for when offer 112 will be valid again after redemption limits 118 are met. Discontinuation code 129 prevents inclusion of an offer from the list of offers if the offer is subject to a redemption limit and the redemption limit has been met as indicated by the tracking code. Presentation code 128 allows for the presentation of the list to an application, such as smartphone application 10, which will present the information to the user. Distribution code 104 works in concert with smartphone application 10 of the present invention to present offers 112 to the user. If a registered user initiates smartphone application 10 at a time 114 when an offer 112 is not valid, that offer 112 is not included on the list that is presented to the user at that time. Presentation code 128 organizes the input 106 for use in smartphone application 10. In smart phone application 10, for example, locations 108 and offer types 116 are shown on the first screen of user interface 14, and the rest of input 106 is not shown until subsequent pages.

Tracking code 130 allows for the tracking of the redemption of offer 112. Offers 112 that have been tracked as already having been redeemed within the parameters set by the business customer will not be listed for registered users when offer software product 100 is executed and smart phone application 10 is initiated. Another application of tracking code 130 is used when the business customer has designated that offer 112 will only be available to a certain number of users, such as the first 500 takers, for example. Tracking code 130 tracks how many users have redeemed the limited offer and the number is provided through smartphone application 10 with the information about offer 112/20, as shown in FIG. 1C. If offer 112 has achieved the total number of users allowed by redemption limit 118, it will not display offer 112 in the list of available offers 112, but will instead display a message that offer 112 is no longer available. This message is coupled with the time frame 119 information telling the user when, if ever, offer 112 will be available again.

Offer software product 100 also includes opt in opt out code 132, which allows an individual location 108 to opt out of all offers created for them by the business customer. All offers 112 created for locations 108 that have opted out of will not be available to users for that location 108. Opt in opt out code 132 also allows individual location 108 to opt in to offers created for them by the business customer.

Offer software product 100 also includes inactive code 131 and active code 133. Inactive code 131 allows business customers to create offers 112 for groupings 110 and then set the offer as inactive for all locations 108 in the group. The distribution code 104 will not list offers 112 that are set as inactive. Active code 133 allows individual locations 108 within grouping 110 to then review the inactive offers 112 and select and activate those offers 112 they wish to offer.

Offer software product 100 also includes texting code 134 for sending text alerts to users that have opted in for text alerts from a business location. Texting code 134 includes user contact information code 136, texting input code 137, opt out code 139, and sending code 138. Texting code 134 includes user contact information code 136 for receiving user contact information for users that have selected to receive text alerts from a location of the business customer. Texting input code 137 works very similarly to receipt code 102. Business customers can create text alerts for groupings 110 of locations 108. They do this by providing input 142 including the message 144 to be texted, when to send the message 146, what grouping 148 will send the message if one of its locations is selected, and what locations 150 will send the message if selected. All users of locations 108 that have chosen to receive text alerts from an individual location 108 or location 108 within a grouping 110 will receive the text alert message 144 created for them. The text message 144 can be scheduled to be sent at a particular date and time 146. Opt out code 139 allows locations 108 or business customers to opt out of having text alerts sent on their behalf even if requested by a user. Sending code 138 is for sending message 144 at the appropriate time 146. The user contact information is stored by offer software product 100 and is not available to the business customer.

Offer software product 100 also includes social network code 140 for creating and sharing information on locations 108 pages of social networking sites, such as those marketed under the Facebook and Twitter trademarks. Social network code 140 works very similarly to receipt code 102. Business customers can create messages to be posted for groupings 110 of locations 108. All locations 108 that have a social networking site listed in their location record within a grouping 110 will have the message posting appear on their social networking site. The social media message can be scheduled to be sent at a particular date and time. Business customers can also choose to opt out of social media messages sent on their behalf. Business customers can also post social media messages for their individual locations 108.

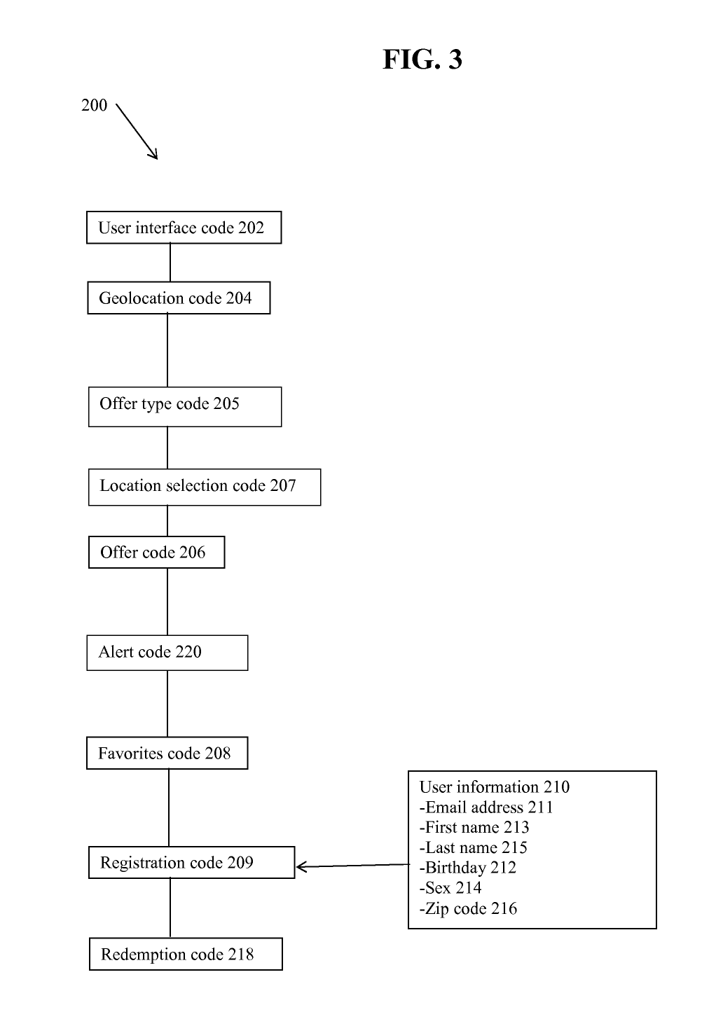

Now referring to FIG. 3, the functionality of smartphone software product 200 is shown. Smartphone software product 200 allows for smartphone application 10 of the present invention and some of the functionalities described herein with reference to smartphone software product 200 are understood to be functions of smartphone application 10 that were not shown in FIGS. 1A-1C. Smartphone software product 200 includes user interface software code 202 for providing a user interface on the smartphone; geolocation code 204 for identifying locations within a geographical range from a user; offer type code 205 for displaying offer types along with locations; location selection code 207 for allowing a user to select a location; offer code 206 for indicating offers available from the selected locations; alert code 220 for allowing users to select locations from whom to receive alerts; favorites code 208 for allowing users to select locations as favorites; and registration code 209 for accepting user information 210, such as email address 211, first name 213, last name 215, birthday 212, sex 214, and zip code 216 for registration with smartphone application 10. Registration allows users to redeem limited offers and targeted offers through the provision of redemption codes 26, as shown in FIG. 1C. Registered users' redemption of offers is tracked so that more information on offer availability is available to them. Smartphone software product 200 also includes redemption code 218 for providing the user with redemption code 26 on the smartphone that is redeemable at a location 14 with the display of the redemption code 26 on the smartphone. As a clarification redemption code 26 is a visible code provided to the user to be displayed on the smartphone to redeem offers. Redemption code 218 is software code that is part of the smartphone software product 200.

The offer distribution system software product of the present invention includes offer software product 100 and smartphone software product 200. Its functionality is therefore depicted in FIGS. 2 and 3.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

What is claimed is:

1. A smartphone application for use by a user on a smartphone with geolocation capabilities:
wherein said smartphone application comprises a user interface;
wherein said user interface indicates locations in a geographical range from the user, wherein locations comprise locations operated by business customers contracting with an application controller;
wherein said user interface indicates offer types from the locations in the geographical range from the user;
wherein said locations are selectable by the user;
wherein if the location is selected, said user interface indicates offers associated with said offer types;
wherein said offers are not indicated if said offers are not valid at a time when the location is selected by the user;
wherein said offers are not indicated if said offers are not redeemable at the time when the location is selected;
wherein said user interface indicates whether said offers have redemption limits; and
wherein said user interface provides redemption codes for said offers if said offers have redemption limits.

2. The smartphone application as claimed in claim 1, wherein said business customers are selected from a group consisting of restaurants, bars, and stores.

3. The smartphone application as claimed in claim 1, wherein said smartphone application allows the user to select favorite locations from among the locations and wherein said smartphone application allows the user to review offers from said favorite locations regardless of whether said favorite location is in the geographical range from the user.

4. The smartphone application as claimed in claim 1, wherein said smartphone application allows users to select alert locations from among the locations indicating that the user opts to receive messages from said alert locations.

5. The smartphone application as claimed in claim 4, wherein said message receipt is via SMS.

6. The smartphone application as claimed in claim 1, wherein said smartphone application accepts demographic information from the user for registration with said smartphone application.

7. The smartphone application as claimed in claim 6, wherein said smartphone application allows the user to opt to receive targeted offers from said businesses based on the demographic information.

8. The smartphone application as claimed in claim 1, wherein said smartphone application allows the user to enter the geographical range.

9. The smartphone application as claimed in claim 1, wherein if said offers have redemption limits, said offers are redeemable at the locations when the user displays said redemption code on the smartphone.

10. A computerized promotion management software system comprising a server, a network connection, a computer readable medium in communication with the server, and an offer software product stored on the computer readable medium and executable by the server, wherein said offer software product comprises:
receipt code for receiving input from a business customer through the network connection, wherein the input comprises:
locations operated by the business customer;
groupings of the locations;
offers;
any offer restrictions on the offers;
times when the offers are valid;
offer types of the offers;
whether the offers have redemption limits;
any redemption limits on the offers; and
a time frame indicating when the offers will be available again if the redemption limits are reached; and
distribution code for distributing offers to a user comprising:
geolocation code for receiving geolocation information for the user;
location code for compiling a list of the locations within a geographical range from the user;
offer code for compiling a list of offers and offer types associated with the offers, wherein the offers on the list are available for redemption at a time that said distribution code is executed; and
presentation code for presenting the lists of locations, types of offers, and offers to an application for use by the user.

11. The computerized promotion management software system as claimed in claim 10 wherein said offer software product further comprises tracking code for tracking at least a number of times the user has redeemed the offer and a total number of users that have redeemed the offer.

12. The computerized promotion management software system as claimed in claim 11, wherein said distribution code further comprises discontinuation code that prevents inclusion of an offer from the list of offers if the offer is subject to a redemption limit and the redemption limit has been met as indicated by said tracking code.

13. The computerized promotion management software system as claimed in claim 10 wherein said offer software product further comprises opt in opt out code for allowing a location operated by the business customer that operates more than one location to opt into and opt out of offers created for the location by the business customer.

14. The computerized promotion management software system as claimed in claim 10 wherein said offer software product further comprises:
inactive code for allowing the business customer to set an offer created for a grouping of locations as inactive; and
active code for allowing locations within the grouping of locations to review inactive offers and select and activate inactive offers that the locations desire to offer.

15. The computerized promotion management software system as claimed in claim 10, wherein said offer software product further comprises template code for creating templates of offers.

16. The computerized promotion management software system as claimed in claim 10, wherein said offer software product further comprises social networking code for distributing offers via social networking websites.

17. The computerized promotion management software system as claimed in claim 10, wherein said offer software product further comprises texting code for sending offers to users that have opted to receive offers from a location regardless of the user's geolocation, wherein said texting code comprises:
user contact information code for receiving user contact information when a user selects a location from whom to receive offers;
texting input code for receiving input from the business customer, wherein the input received by said texting input code comprises a message for users who select a location from whom to receive offers, when to send the message, what grouping of locations will send messages if at least one location from the grouping is selected by the user for message receipt, and what locations will send messages if selected by the user for message receipt;
opt out code for allowing locations to opt out of sending messages to users that have selected the location for message receipt; and
sending code for sending the message to the users that have selected the location for message receipt.

18. An offer distribution system software product for the creation of offers and distribution of said offers via a smartphone application, said offer distribution system software product comprising:
an offer software product storable on a computer readable medium and executable by a server, comprising:
receipt code for receiving input from a business customer through the network connection, wherein the input comprises:
locations operated by the business customer;
groupings of the locations;
offers;
any offer restrictions on said offers;
times when said offers are valid;
offer types of said offers;
whether said offers have redemption limits;
any redemption limits on said offers; and
a time frame indicating when said offers will be available again if the redemption limits are reached;
distribution code for distributing said offers to a user comprising:
geolocation code for receiving geolocation information for the user;
location code for compiling a list of the locations within a geographical range from the user;
offer code for compiling a list of said offers and said offer types associated with the offers, wherein said offers on the list are available for redemption at a time that said distribution code is executed; and
presentation code for presenting said lists of locations, said types of offers, and said offers to a smartphone application for use by the user;
tracking code for tracking at least a number of times the user has redeemed said offer and a total number of users that have redeemed said offer;
discontinuation code that prevents inclusion of said offer from said list of offers if said offer is subject to a redemption limit and the redemption limit has been met as indicated by said tracking code;
opt in opt out code for allowing a location operated by the business customer that operates more than one location to opt into and opt out of said offers created for the location by the business customer;
inactive code for allowing the business customer to set said offer created for a grouping of locations as inactive;
active code for allowing locations within the grouping of locations to review inactive offers and select and activate inactive offers that the locations desire to offer;
template code for creating templates of offers; and
texting code for sending offers to users that have opted to receive offers from a location regardless of the user's geolocation, wherein said texting code comprises:
user contact information code for receiving user contact information when the user selects a location from whom to receive said offers;
texting input code for receiving input from the business customer, wherein the input received by said texting input code comprises a message for users who select a location from whom to receive offers, when to send the message, what grouping of locations will send messages if at least one location from the grouping is selected by the user for message receipt, and what locations will send messages if selected by the user for message receipt;
opt out code for allowing locations to opt out of sending messages to users that have selected the location for message receipt; and
sending code for sending the message to the users that have selected the location for message receipt; and
a smartphone software product stored on a smartphone readable medium and executable as said smartphone application by a smartphone with geolocation capabilities, wherein said smartphone software product comprises:
user interface code for providing a user interface on the smartphone;
geolocation code for identifying and indicating locations within a geographical range from a user, wherein locations comprise locations input by the business customer executing said receipt code of said offer software product;
offer type code for indicating said offer types available at locations within the geographical range from the user;
location selection code for allowing the user to select a location;
offer code for indicating said offers corresponding to said offer types indicated as available at the location selected by the user, wherein said offers are not indicated if said offers are not valid at a time when the user selects the location from said list of locations within the geographical range and said offers are not indicated if said offers are not redeemable at the time when the user selects the location from said list of locations within the geographical range;
alert code for allowing the user to opt in to receive said messages from locations selected by the user;
registration code allowing users to register for a service;
redemption code for providing the user with a code on the smartphone that is redeemable at a location with the display of the code on the smartphone; and
favorites codes for allowing the user to select favorite locations from the locations, wherein the user can see offers from favorite locations regardless of the user's geolocation.

19. The offer distribution system software product as claimed in claim 18, wherein the sending of said sending code of said texting code of said offer software product and the receiving of said alert code of said smartphone software product is via SMS.

20. The offer distribution system software product as claimed in claim 18, further comprising social networking code for distributing offers via social networking websites.
